(19) United States
(12) Patent Application Publication
(10) Pub. No.: US 2019/0059133 A1
(43) Pub. Date: Feb. 21, 2019

(54) Sensors for Training Data Acquisition in an Intelligent Electronic Oven

(71) Applicant: The Markov Corporation, Dover, DE (US)

(72) Inventors: Nick C. Leindecker, Portola Valley, CA (US); Leonard Robert Speiser, Los Altos, CA (US); Arvind Antonio de Menezes Pereira, Milpitas, CA (US)

(21) Appl. No.: 15/678,373

(22) Filed: Aug. 16, 2017

(51) Int. Cl. H05B 6/64; G06N 99/00; A23L 5/10

(52) U.S. Cl. CPC H05B 6/6467; G06N 99/005; H05B 6/6438; A23L 5/15; H05B 6/645

(57) ABSTRACT

Approaches relating to electronic ovens are disclosed. One approach involves an electronic oven with a heating chamber and an energy source that is coupled to an injection port in the heating chamber for introducing an application of energy into the chamber. The electronic oven also comprises a control system to adjust a distribution of the application of energy in the heating chamber, and a set of radio frequency (RF) responsive sensors in the heating chamber. Each RF responsive sensor in the set of RF responsive sensors directly responds to the application of energy in the heating chamber. The control system includes a machine learning system. The control system uses data from each RF responsive sensor in the set of RF responsive sensors to create a set of training data. The control system uses the set of training data to train the machine learning system.

### BACKGROUND

Numerous trends in modern technology have led to the widespread adoption of machine learning and artificial intelligence algorithms across a broad spectrum of industries, but the application of artificial intelligence to certain sectors is sometimes held up by a lack of available training data. A human brain can learn to recognize a pattern or conduct a classification task with a limited amount of training data. For example, a human brain can learn what a steak looks and feels like when it is fully cooked after just a few samples. However, modern machine intelligence algorithms are lacking in this regard and require large volumes of digitized training data before they are fully trained for a given task. As a result, fields where training data is not readily available in digital form present a stumbling block for machine intelligence applications.

In certain applications, the lack of available training data can be overcome because the training data itself can be easily generated using a computer. For example, using an evaluative feedback approach to train an artificial intelligence to play chess can generate training data for the artificial intelligence as fast as a move in the chess game can be digitally modeled. As entire chess matches can be simulated in milliseconds, generating a large volume of training data for the artificial intelligence is a trivial task. However, training an artificial intelligence using a training environment that includes physical reactions taking place in the real world is not as easy. For example, to train an artificial intelligence how to cook an item, the item must actually be cooked, which is a task that occurs on the scale of minutes instead of milliseconds. These applications are therefore thousands of times slower than those that exist in a purely digital realm.

Furthermore, in some applications, the training data generated may be an incomplete picture of the environment. In other words, what is observable in the training data might not fully capture what is happening with the actual process that the machine intelligence is trying to learn. For example, heating an item in an oven and using the surface temperature as training data suffers from not knowing what is happening on the inside of the item. The same observed condition for an item could reflect two totally different real, but unobserved, states for the system. This is referred to as the hidden states problem, and can be difficult to overcome when a limited number of sensors are used to interrogate the condition of a real-world process.

For the above reasons, training an artificial intelligence to conduct actions that are constrained by physical reactions such as cooking food is difficult because of a lack of accurate and readily available training data.

### SUMMARY

Various methods and systems that relate to electronic ovens and energy responsive sensors within electronic ovens are disclosed.

One such system is an electronic oven that has a control system with a machine learning system. The electronic oven also includes a set of radio frequency (RF) responsive sensors that obtain training data for the machine learning system. The electronic oven has a heating chamber and an energy source that is coupled to an injection port in the heating chamber for introducing an application of energy into the chamber. The control system adjusts a distribution of the application of energy in the heating chamber. Each RF responsive sensor in the set of RF responsive sensors directly responds to the application of energy in the heating chamber. The control system uses data from each RF responsive sensor in the set of RF responsive sensors to create a set of training data. The control system uses the set of training data to train the machine learning system.

One such method is a method for training a machine learning system for an electronic oven. The method includes applying an application of energy to a heating chamber of the electronic oven from an energy source via an injection port in the heating chamber. The method also includes adjusting a distribution of the application of energy in the heating chamber using a control system. The method also includes sensing the distribution of the application of energy in the heating chamber using a set of RF responsive sensors. The set of RF responsive sensors are located in the heating chamber and include at least two elements. The method also includes creating a set of training data for the machine learning system using data from each RF responsive sensor in the set of RF responsive sensors. The method also includes training the machine learning system using the set of training data.

### BRIEF DESCRIPTION OF THE DRAWINGS

FIG. 1 illustrates two intelligent electronic ovens where one of the ovens obtains training and state data by observing a condition of the item in the oven, and the other obtains training and state data by directly observing the energy applied to the chamber to illustrate benefits associated with some of the approaches disclosed herein.

FIG. 2 illustrates a method for training a machine intelligence system using training data from an energy responsive set of sensors in accordance with some of the approaches disclosed herein.

FIG. 3 provides two photographs of an energy responsive set of sensors placed in an electronic oven in accordance with some of the approaches disclosed herein.

FIG. 4 provides block diagrams and waveform plot for light emitting diode (LED) sensor elements in accordance with some of the approaches disclosed herein.

FIG. 5 provides a block diagram and waveform plot for a fully rectified LED sensor element in accordance with some of the approaches disclosed herein.

FIG. 6 illustrates two intelligent electronic ovens with elements that are physically arranged to detect energy with different polarizations in accordance with some of the approaches disclosed herein.

### DETAILED DESCRIPTION

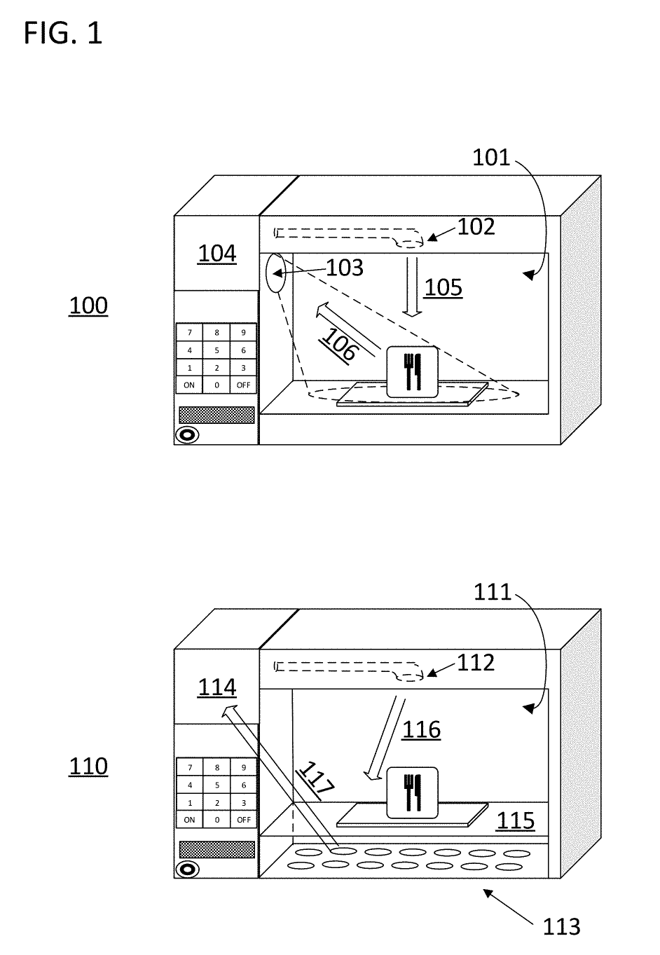

A system of sensors and associated methods are disclosed that improve the functionality of an intelligent electronic oven. The disclosed approaches improve the functionality of an electronic oven that is augmented with a machine learning system by directly observing a distribution of energy in the electronic oven and using the obtained data to train or guide a machine intelligence system in the intelligent electronic oven. Some of the approaches disclosed herein can be beneficially applied to electronic ovens that alter the distribution of energy within their heating chambers by altering their configurations between a large number of potential configurations. The electronic ovens of FIG. 1 can be used to explain the benefit of some of the disclosed approaches.

FIG. 1 illustrates a first electronic oven 100 in which energy is applied to a heating chamber 101 via an injection port 102. In electronic oven 100, the effect of the energy applied to the item is observed by a visible light and/or infrared camera coupled to a viewport 103 in the chamber. The information captured by the camera is then used by a control system 104 to adjust the energy applied to the chamber. Thus, a feedback control loop is created by the energy 105 applied to the item, the reaction of the item to that energy, the observed data 106 regarding that reaction, and control system 104. The control system can include a machine learning system that uses data 106 to train itself, to train other machine learning systems, or to guide a specific heat job.

The system described with reference to FIG. 1 exhibits certain drawbacks which stem from the fact that the reaction of the item itself is in the control loop. Energy is applied to the food, and the reaction of the food to the energy is what guides any adjustment to the applied energy. As such, the specific characteristics of the energy applied to the chamber and how that energy was distributed within the chamber is known only indirectly. In specific approaches in which the electronic oven can be designed to create numerous and widely variant distributions of energy to the chamber, the loss of this information can be detrimental to the functioning of the control loop and machine intelligence system. This is particularly problematic because the characteristics of the item placed in the chamber will affect how a given application of energy to the chamber ends up being distributed within the chamber due to reflections of energy off the item. As such, it can be difficult to know what distribution of energy will result from any command provided by the control system.

FIG. 1 also includes a second electronic oven 110 in which the distribution of energy applied to the chamber is observed directly. Electronic oven 110 includes a chamber 111 to which energy is applied via an injection port 112 in the chamber. This application of energy creates a distribution of energy in the chamber which is directly sensed by a set of energy responsive sensors 113. The energy responsive sensors can be RF-responsive sensors. The energy responsive sensors 113 then provide a direct measurement of the distribution of electromagnetic energy in the chamber to control system 114. As illustrated, the energy responsive sensors 113 of electronic oven 110 are located below an RF-transparent wall of the chamber. In this case, the wall of the chamber is a ceramic floor 115 of the chamber.

Electronic oven 110 provides control system 114 with a more direct measurement of the distribution of energy in the chamber than electronic oven 100. Specifically, one that is not masked by an observation of the item's idiosyncratic heating response. Furthermore, if the energy responsive sensors are placed proximate to the item, they can provide an estimate of how much energy is being applied to the item. Energy 116 is applied to the chamber, is sensed directly by energy responsive sensors 113, and generates data 117 that is provided to the control system. As such, training data regarding the distribution of energy in the chamber can be gathered more quickly and more accurately in electronic oven 110 than in electronic oven 100. Indeed, electronic oven 110 could be run without an item located in the chamber at all such that the data observed was used only to inform control system 114 as to how the various configurations of the oven varied the distribution of energy in the chamber.

The approaches of electronic oven 100 and 110 were described separately to accentuate the benefit of observing the distribution of energy in the chamber directly. However, the approach of electronic oven 110 can be augmented with a method for observing the response of the item to heat such as by utilizing both data 106 and 117. Machine intelligence applications often improve by being provided with numerous types of data regarding the task they are being trained for. As a basic example, an electronic oven could include both illustrated feedback paths (i.e., those carrying data 106 and 117). The training data for the machine intelligence system would then include both: (i) data concerning the response of the item to an application of energy; and (ii) a direct measurement of the distribution of that application of energy. Indeed, the data obtained by the set of energy responsive sensors can be combined with data obtained from a multitude of sensor and control sources to train and assist the machine intelligence system of an intelligent electronic oven.

Electronic ovens in accordance with this disclosure can include control systems that adjust the distribution of energy in the chamber in various ways. For example, electronic oven 110 includes an energy source, such as a magnetron, that is coupled to injection port 112 in heating chamber 111. The magnetron can be coupled to the injection port using a waveguide. The energy source introduces RF energy into heating chamber 111. The electronic oven could also be configured to adjust the distribution of energy in the heating chamber using control system 114. The intensity of the application of energy can be fixed by, or varied using, control system 114. For instance, the energy source could be augmented with inverter technology to vary the amplitude of the electromagnetic waves introduced to the chamber. The frequency of the electromagnetic waves introduced to the chamber could also be fixed or variant. For example, the application of energy can be microwave energy fixed and centered at a frequency of either 2.45 GHz or 915 MHz. Control system 114 could adjust the distribution of energy in the chamber by altering the frequency and/or intensity of the application of energy. Control system 114 could adjust the frequency of the electromagnetic waves to target interior portions of the item in the chamber.

The control system of an electronic oven in accordance with certain approaches in this disclosure could also adjust the distribution of energy in the chamber by altering the state of a set of variable reflectance elements in the chamber. Examples of such approaches are described in U.S. patent application Ser. No. 15/619,390, filed Jun. 9, 2017, and entitled “Electronic Oven with Reflective Energy Steering,” 62/434,179, filed Dec. 14, 2016, and entitled “Electronic Oven with Reflective Energy Steering,” and 62/349,367, filed Jun. 13, 2016, and entitled “Electronic Oven with Reflective Beam Steering Array,” all of which are incorporated by reference herein in their entirety for all purposes. The manner in which the variable reflectance elements in the chamber were altered could be controlled by a machine intelligence system such as the ones described in U.S. patent application Ser. No. 15/467,975, filed Mar. 23, 2017, and entitled “Electronic Oven with Infrared Evaluative Control,” which is incorporated by reference herein in its entirety for all purposes.

The examples above benefit from direct sensing of the energy in the heating chamber for several reasons. In these examples, the number of potential configurations of the electronic oven can be immense, such that it would be difficult to model the distribution of energy in the chamber for all of those potential configurations to generate training data for every potential configuration. Furthermore, the issue of having too many configurations to model is compounded by the fact that each unique item placed in the electronic oven will alter the distributions of each of those potential configurations. Therefore, these approaches benefit from a source of training data that measures the energy distribution resulting from a given configuration of the electronic oven directly.

The energy responsive sensors can be positioned within the electronic oven in numerous ways. The sensors can be located in the heating chamber and can include at least two elements. The sensors could be arranged in a regular array or irregular array. The sensors can be located in a single array or multiple arrays. The array or arrays could be designed to sample the distribution of energy along a single chamber wall of the electronic oven. The term wall, used in this context, is meant to include the floor and ceiling of the chamber. The array or arrays could be built directly into the walls of the chamber. The sensors could be integrated into a wall of the chamber or attached to a wall of the chamber. Alternatively, the array or arrays could be implemented on a substrate that was separate from the walls of the chamber such as a rigid printed circuit board or flex circuit. The substrate could be wholly transparent to RF except for the RF-responsive sensors.

The array or arrays could be fixed within the chamber, removable from the chamber as a unit, or adjustable within the chamber using an actuator. The arrays could also be designed to be swept through the chamber volume, such as by lifting an array up in a direction normal to a floor of the chamber, or by rotating an array in the chamber. As such, the same distribution of energy in the chamber could be sampled multiple times as the array was being swept or rotated through the chamber to produce a single snapshot of that distribution of energy. For example, tomography sampling of the chamber volume could be achieved by sweeping an array of sensors that was the size of the base of the chamber through a range of Z positions towards the ceiling of the chamber. Alternatively, if the sensors were located on a flex circuit substrate, the sensors could be positioned around a phantom item to obtain irregular tomographic samples of the chamber that are directly applicable to items of a particular shape.

The sensors could be designed to be easily removed from the chamber such as by being placed on a test board with fastening devices to hold the test board in place during testing, while allowing it to be easily removed when the electronic oven was deployed in the field. As a specific example, the sensors could be located on a removable printed circuit board and could be attached to a wall of the chamber via a hook and loop connection or other connecting means. As another example, the sensors could be located on a removable printed circuit board and could be removably attached to a permanent portion of the electronic oven responsible for moving items placed in the heating chamber during heating. In particular, the board could be connected in place of a movable tray that would otherwise be located in the electronic oven for moving food through the chamber during heating. The sensor array could be kept in the electronic oven only during calibration, only in the factory for research and development, or it could be an integral part of the electronic as deployed in the field. For example, an array of sensors could be integrated behind a floor panel or coincident with walls of the chamber to provide real-time feedback to the control system.

The array or arrays of sensors could be designed with a density sufficient to get an accurate sample of the distribution of energy in the chamber. For example, the sensors could be spaced such that there was at least one sensor for every 10 cm² of one or more of the chamber's interior surfaces. However, the sensors would not generally need to be spaced tighter than a spacing equal to one half of the wavelength of the shortest wavelength of energy that the energy source of the electronic oven was designed to introduce to the chamber. The sensors could be located behind a false wall of the chamber. For example, the sensors could be located below a false floor and/or above a false ceiling of the chamber. The false wall can be referred to as “false” in that it is a physical barrier but is transparent to the electromagnetic waves provided to the heating chamber by the energy source.

The sensors can directly sense the distribution of energy in the chamber in various ways. The sensors can respond directly to the energy applied to the chamber such that each of them individually generated a detectable analog signal in response to the applied energy that varied along with the distribution of the application of energy to the chamber. The sensors can also be selected from variant different types of sensors such as a combination of light emitting diodes with a visible light camera. The sensors could also be antennas configured to capture information and channel it out of the chamber via a wired connection to an analog digital converter integrated circuit located outside of the heating chamber. The sensors can also be designed to have different characteristics for detecting electromagnetic signals of a specific frequency, range of amplitudes, and polarization, and the characteristics of the sensors can vary across the chamber of the electronic oven. For example, the set of sensors could be divided into different subsets where each of the subsets was designed to detect to detect electromagnetic radiation with a particular polarization, frequency, or amplitude.

The control system of the electronic oven can include a machine learning system. The machine learning system could include a classifier, an evaluative feedback loop, a reinforcement learning system, a deterministic planner, a neural network, a support vector machine, or any other machine learning system, algorithm, or architecture. The training data can also be the data generated during a discovery phase of a machine intelligence system that alternates between exploitation and discovery phases. The electronic oven could create a set of training data for the machine learning system using data from each sensor in the electronic oven. The training data could be used to update a set of weights in a neural network, be used to derive a plan cost for a deterministic planner, or to evaluate a reward function for a reinforcement learning system. The training data could be used in real time to guide an online machine learning system or it could be collected during a training session and used to guide later heat jobs. The training data could include data from the energy responsive sensors and corresponding data regarding a configuration of the electronic oven. For example, if the electronic oven could place itself in different configurations to adjust the distribution of energy in the electronic oven that result from a given application of heat, the commands used to adjust that distribution, or a state used to describe that configuration, could be paired with the corresponding sensor data to create an entry in the training data for the machine intelligence system.

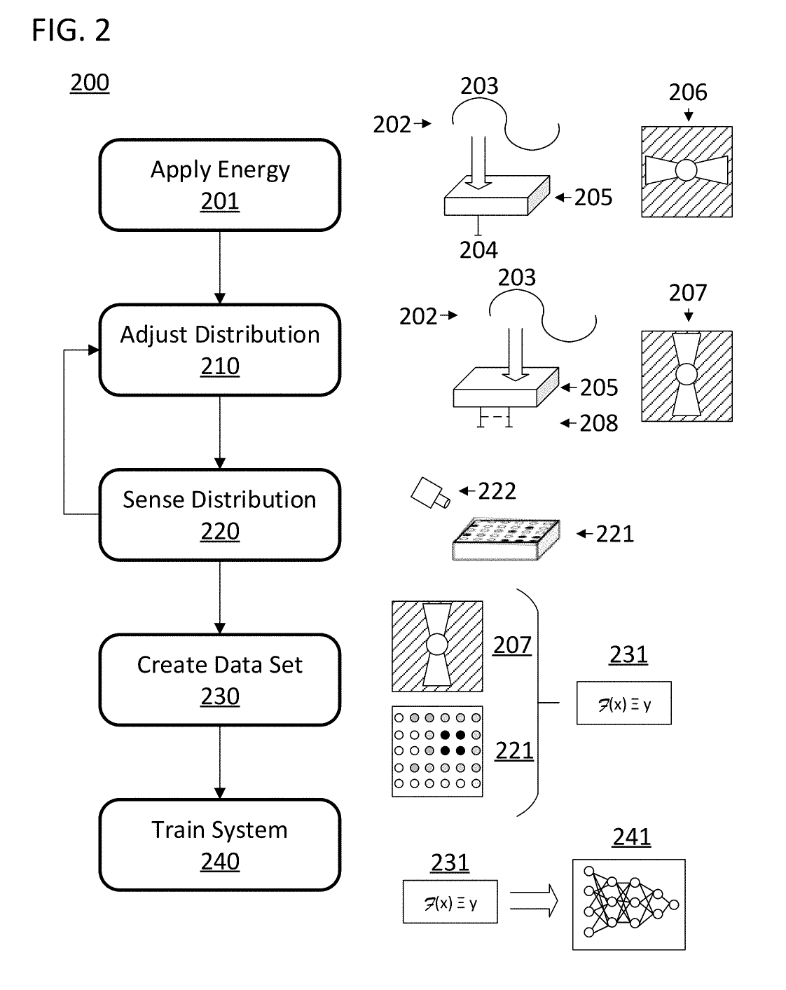

FIG. 2 includes flow chart 200 of a method for training a machine learning system for an electronic oven. In step 201 energy is applied to a heating chamber of the electronic oven from an energy source via an injection port in the heating chamber. As illustrated, the application of energy 202 can include a local maximum 203 at a specific point 204 in the chamber 205. The application of energy could have a distribution in the chamber owing to a configuration of the electronic oven. For example, the electronic oven could have a specific physical configuration set by the orientation of a variable reflectance element 206. The variable reflectance element 206 could be a single variable reflectance element in a set of variable reflectance elements that adjust the distribution of the application of energy in the chamber. In step 210, the distribution of energy in the chamber is altered using a control system. As illustrated, this could involve local maximum 203 moving from point 204 to point 208. Also, the adjustment could involve the control system altering the configuration of the electronic oven. For example, the control system could alter the reflectance of a variable reflectance element such as by altering the physical orientation of variable reflectance element 206 to another orientation 207.

In step 220, the distribution of the application of energy in the chamber is sensed using a set of sensors. The sensors are located in the heating chamber and include at least two elements. In the illustrated case, the sensors include a regular array of sensors 221. The individual elements of the array are light emitting diodes (LEDs) that are electrically coupled to antennas. Information regarding the distribution of energy is obtained by a visible light camera 222 with a view of the array. The dynamic range of the application of energy in the chamber can be used to set the electrical properties of the antennas and LEDs such that the intensity of light output by the LEDs is indicative of where on the range from minimum to maximum the intensity of the electromagnetic field is at the point occupied by the sensor. The visible light camera can then obtain information regarding the relative intensity of the distribution of the application of energy to the chamber by sensing the intensity of light generated by each element of the array.

Flow chart 200 loops back to step 210 from step 220 because the distribution in the electronic oven could be adjusted and measured numerous times. In each iteration, the item in the electronic oven could be modified and/or the configuration of the electronic oven could be altered to modify the distribution. For example, one iteration of steps 210 and 220 could be conducted while the heating chamber was sealed and a variable reflectance element in the chamber was moved from one orientation to another. As another example, one iteration of steps 210 and 220 could be conducted by opening the chamber and replacing the item inside with another item.

In step 230, data from each sensor in the set of sensors is used to create a set of training data for the machine learning system. The set of training data can include a set of configurations for the electronic oven and a corresponding set of measurements from the set of sensors. Alternatively, the set of training data can include a set of commands from the control system and a corresponding set of measurements from the set of sensors. The commands could be a sequence of commands used by the control system to adjust the distribution of the energy in the chamber. The sensors can be linear time invariant sensors with no memory such that their current state is an accurate snapshot of the current distribution of energy in the chamber. Sensors with this characteristic will help to ensure that the training data provides an accurate uncorrupted correspondence between commands given by the control system to affect the distribution of energy in the chamber and the actual response of the distribution of energy in the chamber to those commands.

In the illustrated example, an element of training set data 231 represents both the physical configuration of a set of variable reflectance elements used to alter the distribution of energy in the chamber as set in step 210, and a corresponding set of sensor values reflecting the distribution of energy in the chamber as measured in step 220. For example, element 231 could be a set of samples captured by the set of sensors and a corresponding command in the sequence of commands used to alter the configuration of the electronic oven. In such an example, the set of samples would have been taken while the corresponding command was applied to adjust the distribution of energy in the chamber. As another example, element 231 could be a set of samples captured by the set of sensors and a corresponding configuration of the electronic oven. The corresponding configuration could be one that was selected and applied in step 210 from a set of at least five fixed configurations for the electronic oven. In such an approach, adjusting the distribution of the application of energy could involve altering a physical configuration of the oven between a set of at least five fixed configurations. The set of at least five fixed configurations could be defined by the state of a set of variable reflectance elements in the chamber, such as the orientation of a reflective element relative to a dominant polarization of an electromagnetic wave in the chamber. Regardless, the combined data of element 231 describes the functional relationship between the control outputs of the control system of the electronic oven and the resulting distribution of energy in the electronic oven. The methods illustrated by flow chart 200 allow for the rapid discovery of which configurations of the electronic oven will provide the most useful distributions of energy in the chamber for heating a particular surface or volume in the electronic oven.

In addition to the data obtained by the energy responsive sensors located in the chamber, the training data used to train the machine intelligence system can include numerous other values and information regarding the state of the electronic oven, and any item in the oven. For example, the data could represent an overall temperature measurement in the chamber, the visible appearance of an item in the chamber, the surface and core temperature of an item in the chamber, an auditory output from the item in the chamber, an identity or description of the item provided by an operator, etc. The sensors used to obtain the additional training data could include temperature sensors, auditory sensors, RF parameter sensors, humidity sensors, particulate concentration sensors, altitude sensors, ultrasound sensors, ultraviolet or IR sensors, a weight sensor such as a scale, and any other sensors that can be used to obtain information regarding the state of the item, chamber, or oven. For example, the oven could include sensors to detect the power applied to the chamber via the energy source, the return loss from the chamber, an impedance match between the energy source and item or chamber, and other physical aspects of the energy source. In particular, the return loss can be measured to determine a phase change in the item as certain items absorb energy at a much greater degree when they are melted compared to when they are frozen. Impedance matching or return loss measurements could also be applied to detect more subtle changes in the physical characteristics of the item being heated. Additional sensors could detect the humidity of the air exiting the chamber via a ventilation system or within the chamber. Additional sensors could detect a particulate concentration within those volumes to determine if the items were smoking. Additional sensors could detect the weight of the item.

In step 240, the training data is used to train a machine learning system. The data can be used in real time if the machine learning system engages in online learning or discovery. However, the data can also be stored and recalled to train the system at a later time. As illustrated, element 231 is used as a tagged example for training a neural network 241 through back-propagation. The stored data can also be used in combination with online learning approaches. For example, the data describing the distribution of energy in the chamber obtained during a prior run in which no item was in the chamber can be applied as feedback for the training of a neural network while the neural network is being used to heat an item in the chamber. This later use of the neural network could involve information gleaned from the reaction of the item during the present heat job in combination with the prerecorded data. Although the actual distribution of energy in the chamber will be effected by the presence of the item, the added information would assist the neural network as there will still be a relationship between the distribution of energy in the chamber with the item in the chamber and without the item in the chamber.

The set of RF responsive sensors could include an analog sensing means. The input range of the analog sensing means could be set by a physical dimension of the analog sensing means. The analog sensing means could be an antenna or set of antennas located in the electronic oven and configured as described herein for sampling the distribution of energy in the chamber. The antennas could be monopole, dipole, slot, or patch antennas. The antennas could be sized to correspond with a potential dynamic range of the distribution of the application of energy in the chamber. The antennas could be used to generate a rectified RF signal which would then be converted into a DC voltage indicative of the field strength at a specific location within the electronic oven. Alternatively, the antennas could be used to provide power to forward bias an LED which would generate light with a brightness indicative of the field strength at a specific location in within the electronic oven. The execution of step 220 would then comprise forward biasing a set of LEDs using the application of energy to the chamber and detecting an intensity of light and a distribution of light from the set of LEDs using a visible light camera. In any such approach, the input range of the analog sensing mean could be configured to be larger than a potential dynamic range of the distribution of energy in the chamber.

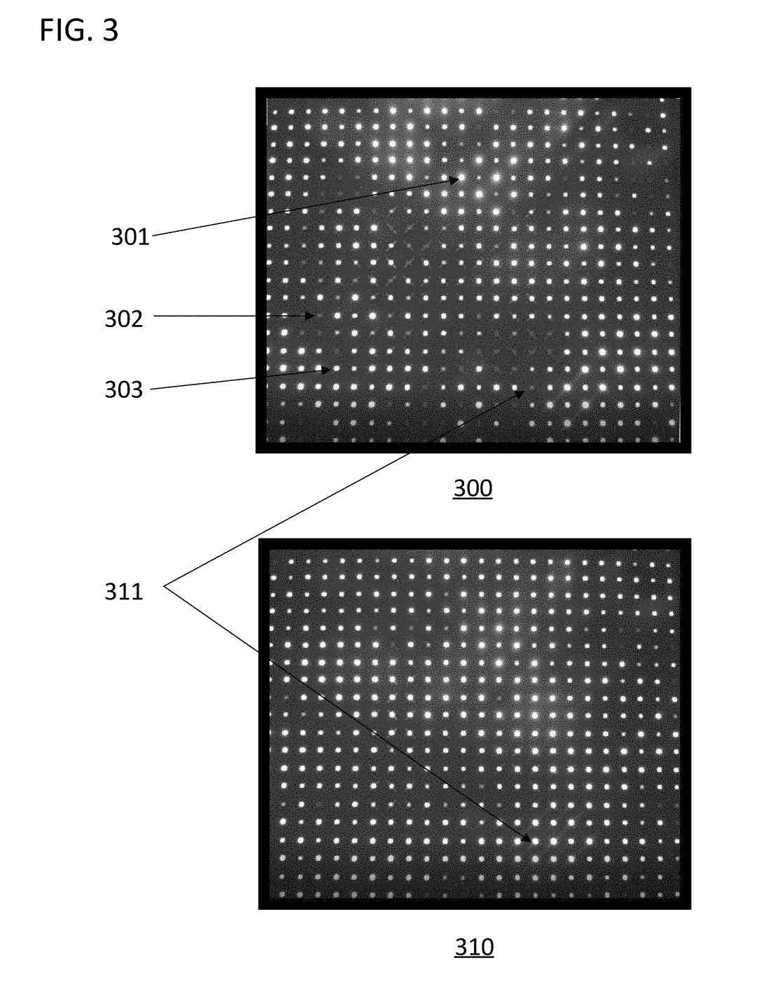

FIG. 3 provides an example of how selecting the appropriate input range for the RF responsive sensors can allow for the generation of meaningful training data. FIG. 3 illustrates a regular array of light emitting diodes electrically coupled to dipole antennas for the purposes of sensing the distribution of energy from an energy source. Image 300 shows the array producing one set of samples while energy is applied from an energy source with the electronic oven in one configuration. Image 310 shows the same array producing a second set of samples while the energy is applied with the electronic oven in a second, different, configuration. Since the size of the antennas, topology of the sensor cell, and characteristics of the LEDs were selected with the dynamic range of the applied energy in mind, each sample of data provides a large amount of data. For example, in image 300 the sample of data shows not only the distribution of energy in terms of the location of dead spots, but also provides information regarding the gradation of hot spots. As seen, some LEDs, such as LED 301, are lit brightly, while some, such as LED 303, are less bright. The array therefore gives off a complex description of the distribution of energy in the chamber. Image 310 illustrates how the same LED 311 can be bright in one configuration and dark in another. The illustration also shows how the distribution of energy in the chamber can vary in a complex form from one configuration to another which is why a machine intelligence system is applied to control the application of energy to the chamber.

The set of sensors could also include an analog to digital conversion means for generating a set of digital data points from a set of samples captured by the set of energy responsive sensors. The set of digital data points could be represented in the training data of the machine intelligence system of the electronic oven. For example, the digital data points could be used directly as the set of samples of the distribution in the electronic oven to form training set data element 231. In approaches that are in keeping with those described with reference to FIG. 3, the analog to digital conversion means could be a visible light camera with a view of the LEDs. These approaches exhibit certain benefits in that the intelligent oven may already have a visible light camera for observing the item in the heating chamber as it is heated. Therefore, in those approaches, few modifications will be required to allow the electronic oven to obtain information from an array of LEDs located in the heating chamber. In other approaches the analog to digital conversion means could be an analog to digital integrated circuit located outside of the chamber that receives electronic signals from the sensors. The analog to digital conversion means could include a set of wires carrying signals from the sensors out of the chamber. The penetration of the cabling could be designed to prevent electromagnetic energy from the electronic oven's main energy source leaking out of the chamber. For example, the porting to the cavity could include a waveguide past cutoff to seal in the energy from the electronic oven energy source while allowing the sensor signals to escape from the chamber. The analog to digital converter could include a multiplexer to sample data from multiple sensors in series.

The different kinds of sensors mentioned above can work in combination with different potential locations for the sensors as mentioned above. For example, sensors in which the analog sensing means was an LED and the analog to digital converter means was a visible light camera could be used in combination with an approach in which the array of sensors was placed below a false floor of the chamber by making the false floor of the chamber transparent to visible light as well as radio frequency radiation. In such an approach, the floor of the chamber would appear to light up as the heating process was in progress which would add an interesting visible element to the use of the electronic oven. Also, any of the approaches disclosed could be used in combination with a board that was only located in the electronic oven during calibration at the factory or during research and development.

The analog sensing means could be antenna arrangements augmented with diodes or other forms of active antennas. The analog sensing means could be net absorbers of energy in the electronic oven. For example, each combination of electrically coupled diodes and antennas could absorb 10 mW to 100 mW of power from the distribution of energy. The analog sensing means could produce a DC voltage or current proportional to the field intensity picked-up by an antenna probe. The antennas could be printed circuit board traces on a printed circuit board. The length of those antennas for purposes of configuring the input range of the analog sensing means would include the effect of parasitic inductances and capacitances on the substrate. The antennas could alternatively be pins extending in a direction normal to a substrate, such as a printed circuit board, on which the diodes were located. The antennas could also have a mix of orientations.

The analog sensing means could produce a rectified signal from the energy in the chamber. The analog sensing means could produce a rectified and filtered signal from the energy in the chamber. The analog sensing means could be configured using low frequency components. The rectified signal could be generated by sampling the signal produced by the antenna arrangement, filtering out any signal with a frequency in the vicinity of twice the frequency of the energy applied to the chamber, and measuring the DC output of the resulting signal. The resulting DC signal would be proportional to the strength of the RF field at that portion of the chamber. The analog sensing means could exhibit various cell topologies involving a rectifying circuit located between and electrically connecting two portions of an antenna.

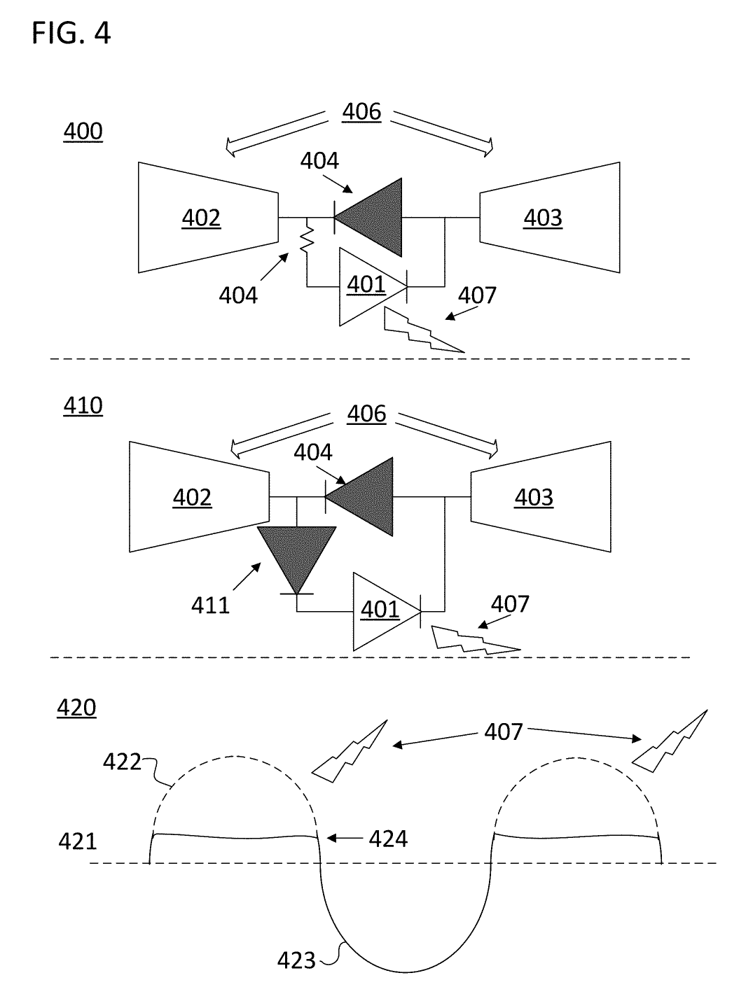

FIG. 4 includes block diagrams 400 and 410 which show two cell topologies for an energy responsive LED sensor. Block diagram 400 includes LED 401 coupled to a dipole antenna with a first portion 402 and a second portion 403. The first portion could be coupled to an anode of the LED via a resistor 404 and the second portion could be coupled to a cathode of the LED. The two portions could also be connected by a rectifying ‘detector’ diode 405 with a lower junction capacitance than the LED 401. Block diagram 410 is similar to block diagram 400 and like portions are labeled accordingly. Block diagram 410 is different in that resistor 404 has been replaced with another rectifying diode ‘detector’ diode 411. Regardless, when field 406 reaches a sufficient strength, diode 401 will be forward biased and emit light 407 of an intensity that is proportional to the field strength.

The LED could be a III-V material LED. For example, the LED could be an InGaN LED. The LED could be chosen such that it does not emit light until the electric field strength reaches a predetermined value that results in substantial heating, such as greater than 6 volts per centimeter. The dipole antenna could be anywhere from 0.5 cm to 2 cm in length. The forward diode bias voltage and the length of the dipole antenna could be configured such that the maximum brightness of the LED matched the maximum expected field strength for any particular point in the heating chamber of the microwave. The LED could be a white LED such as a Luxeon 2835 2D LP with two LED junctions in series and a forward bias voltage of 6 volts.

Waveform plot 420 includes two waveforms plotted against time on x-axis 421. The magnitude of electric field 406 across antennas 402 and 403 is illustrated by waveform 412 where the x-intercept represents zero. The voltage across LED 401 in response to electric field 406 is illustrated by waveform 423 where the x-intercept represents zero and the same scale is used for both waveform 422 and waveform 423. The two waveforms overlap until the field strength is strong enough to forward bias voltage of LED 401 which is marked by reference line 414 in waveform plot 410. While the field strength exceeds the forward bias voltage, light is emitted by the LED. If the frequency is high enough the light will appear continuous to a visible light camera viewing the LED and the apparent brightness of the LED will increase with the magnitude of waveform 422.

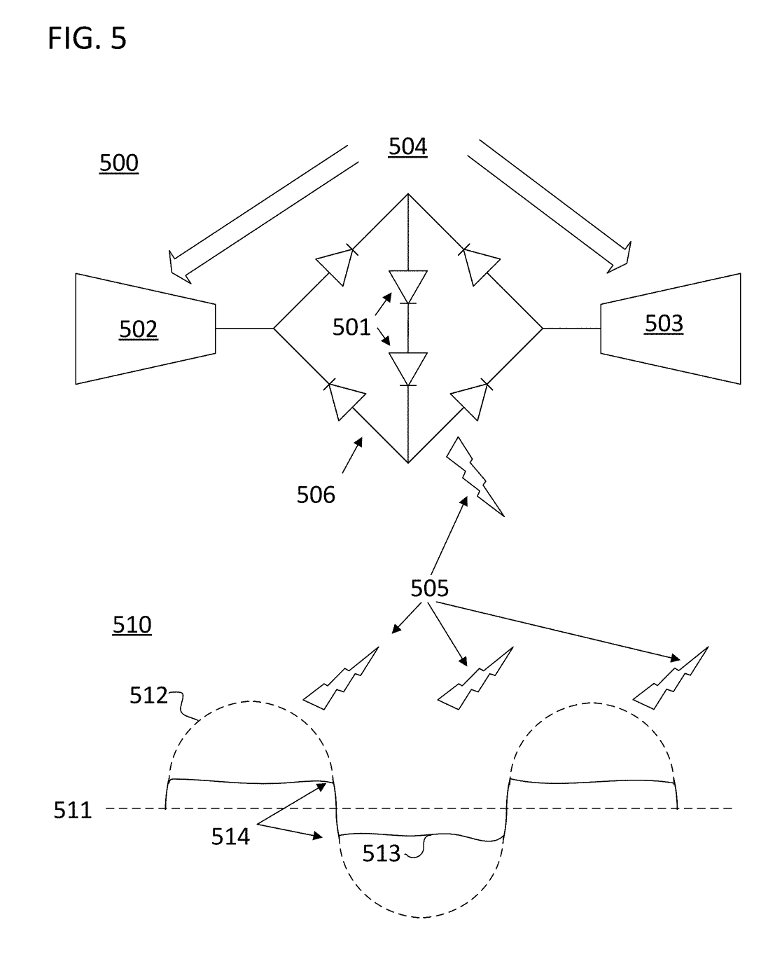

FIG. 5 illustrates another variation for an energy responsive LED sensor cell topology. The approach of FIG. 5 varies from those of FIG. 4 in that multiple LEDs are applied in series and in that the electric field is fully rectified. However, either of these variations can be used separately. FIG. 5 includes block diagram 500 which shows a pair of LEDs 501 electrically coupled to a dipole antenna with a first portion 502 and a second portion 503. When field 504 reaches a sufficient strength, diodes 501 will both be forward biased and emit light 505 of an intensity that is proportional to the field strength. The LEDs could be III-V material LEDs. For example, the LEDs could be InGaN LEDs. The LEDs could be chosen such that they do not light until the electric field strength is greater than 6 volts per centimeter. The dipole antenna could be anywhere from 0.5 cm to 2 cm in length. The forward diode bias voltage and the length of the dipole antenna could be configured such that the maximum brightness of the LEDs matched the maximum field strength for any particular point in the heating chamber of the microwave. The LEDs could be configured and selected such that their combined forward bias voltage was 6 volts.

Waveform plot 510 includes two waveforms plotted against time on x-axis 511. The magnitude of electric field 504 across the antenna formed by portions 502 and 503 is illustrated by waveform 512 where the x-intercept represents zero. The voltage across LEDs 501 in response to electric field 504 is illustrated by waveform 513 where the x-intercept represents zero and the same scale is used for both waveform 512 and waveform 513. The two waveforms overlap until the magnitude of the field strength exceeds the forward bias voltage of LEDs 501 which is marked by reference line 514 in waveform plot 510. While the magnitude of the field strength exceeds the forward breakdown voltage of the two LEDs, light is emitted by the LEDs. If the frequency is high enough the light will appear continuous to a visible light camera viewing the LEDs and the apparent brightness of the LEDs will increase with the magnitude of waveform 512. The resulting signal is fully rectified as LEDs 501 are electrically coupled to antenna portions 502 and 503 via a fully rectifying diode bridge 506. The diode bridge could be a Schottky diode bridge such as an HSMS-2828-TR1G with a 15-volt tolerance and 1 pico-Farad of parasitic capacitance.

Different variations of the structures provided in FIGS. 4 and 5 can be adopted to calibrate the input and dynamic range of the analog sensing means. For example, the number of LEDs in series and their forward bias can be increased in order to set the field strength that will register by turning on the LEDs. In addition, the length of the antennas can be increased to alter the range of field strength that will be reflected by a detectable change in the brightness of the LEDs. The two values can also be adjusted in combination to change the characteristics of the sensors. Since field strength is measured in volts per distance, for an electrically short antenna, where the length is much less than a quarter of the wavelength, an increase in antenna length will provide increasing RF voltage at the detector diode. The forward bias of the LEDs can be set to lock the input field strength that turns on the LEDs to a set value.

As mentioned previously, the set of sensors can be divided into subsets that can respond to electromagnetic energy with different characteristics. For example, sensors that have the approximate configuration described with reference to FIGS. 4 and 5 only respond to electric field vector components of the incident field that are parallel to the main axis of the dipole antenna. Therefore, by orienting the antenna dipoles appropriately, it would be possible to observe the contribution of energy from different incident polarizations. With this information, the machine intelligence system could decompose the light distributions to determine the field intensities in each of the fundamental polarization directions. The information obtained by the sensors could be transmitted from the sensor over a wire connection and processed by an analog to digital converter. The information obtained by the sensors could also be transmitted to a visible light camera by assuring that the sensors in the different subsets generated light in different spectra. For example, a subset with a first orientation could generate red light, a subset with a second orientation could generate green light, and a subset with a third orientation could generate blue light. Indeed, any division of spectrum could be assigned to the various subsets as long as the visible light camera was sensitive enough to discern the differences between the spectra.

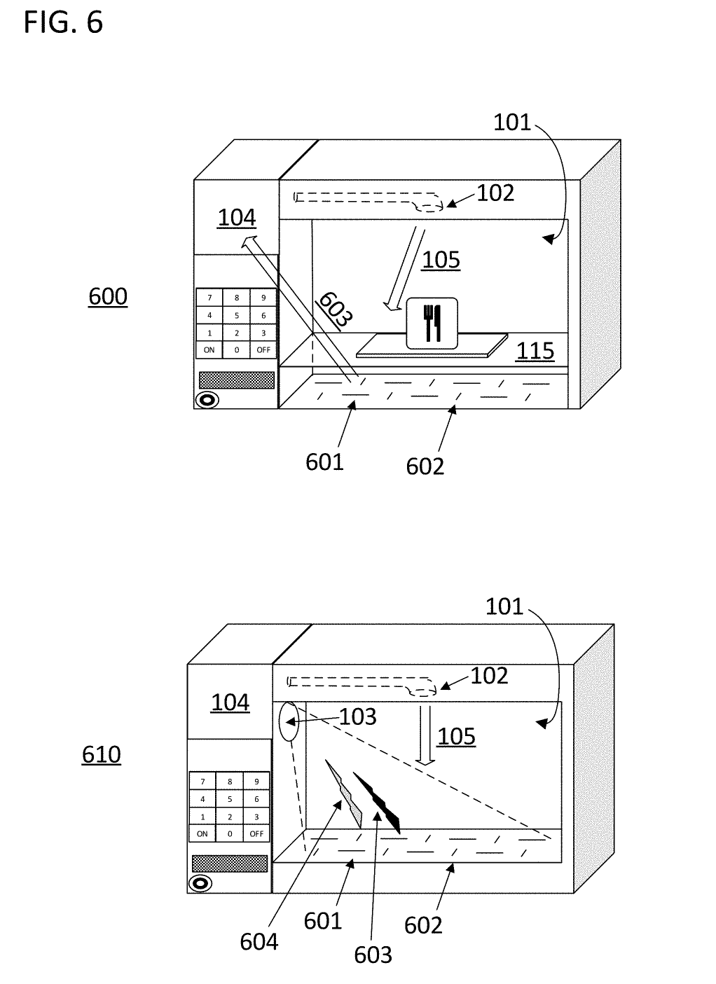

FIG. 6 illustrates two electronic ovens 600 and 610 with like elements from FIG. 1 labeled with the same reference numbers. Electronic ovens 600 and 610 differ from those of FIG. 1 in that the sets of energy responsive sensors are not homogenous. Instead they are divided into two subsets with different orientations. As illustrated by electronic oven 600, a first RF responsive sensor 601 in the array of sensors is physically positioned to detect incoming energy of a first polarization. Specifically, components of the incident field that are parallel with the opening of the chamber will be sensed by RF responsive sensor 601. Also illustrated by electronic oven 600, a second RF responsive sensor 602 in the array of sensors is physically positioned to detect incoming energy of a second polarization. Specifically, components of the incident field that are perpendicular to the opening of the chamber will be sensed by RF responsive sensor 602. The physical composition of sensors 601 and 602 are the same such that they will produce the same kind of signal in response to sensed energy with all else held equal. However, the sensors have different physical orientations so they will respond to components of the electric field with different polarizations. As illustrated, the subsets of sensors are located below a false floor and produce a stream of analog information 603 that is transmitted to control system 114.

The electronic oven can include numerous subsets of sensors with different physical orientations and/or different physical compositions. The sensors physical compositions can be selected such that they generate different kinds of signals or respond to incident energy differently. The different physical orientations and different physical compositions can both affect the type of incident energy that the sensors respond to. Electronic oven 610 provides a specific example of subsets of sensors with different physical orientations to respond to different kinds of incident energy while also having a different physical composition to respond differently to incident energy. In electronic oven 610, sensors 601 and 602 are in subsets that differ as to both physical orientation and physical composition. The subset of sensors that have the same orientation as sensor 601 are configured to generate light in a first spectrum 603. The subset of sensors that have the same orientation as sensor 602 are configured to generate light in a second spectrum 604. For example, the first subset could generate green light and the second subset could generate red light. The two subsets of sensors both produce light that is detectable by a visible light camera with a view of both subsets via viewport 103. Therefore, the visible light camera is able to obtain information regarding the distribution of field strength components in the electronic oven without requiring any preprogrammed information concerning the subsets.

While the specification has been described in detail with respect to specific embodiments of the invention, it will be appreciated that those skilled in the art, upon attaining an understanding of the foregoing, may readily conceive of alterations to, variations of, and equivalents to these embodiments. Any of the method steps discussed above can be conducted by a processor operating with a computer-readable non-transitory medium storing instructions for those method steps. The computer-readable medium may be memory within a personal user device or a network accessible memory. Although examples in the disclosure where generally directed to electronic ovens, the same approaches could be utilized in any application in which a machine intelligence system is in the feedback loop of a system that applies electromagnetic energy to affect an item located in a volume subject to that electromagnetic energy. These and other modifications and variations to the present invention may be practiced by those skilled in the art, without departing from the scope of the present invention, which is more particularly set forth in the appended claims.

1. An electronic oven comprising:
a heating chamber;
an energy source coupled to an injection port in the heating chamber for introducing an application of energy into the heating chamber;
a control system to adjust a distribution of the application of energy in the heating chamber; and
a set of radio frequency (RF) responsive sensors located in the heating chamber;
wherein each RF responsive sensor in the set of RF responsive sensors directly responds to the application of energy in the heating chamber;
wherein the control system includes a machine learning system;
wherein the control system uses data from each RF responsive sensor in the set of RF responsive sensors to create a set of training data; and
wherein the control system uses the set of training data to train the machine learning system.

2. (canceled)

3. The electronic oven of claim 1, wherein:
the set of RF responsive sensors includes an analog sensing means; and
an input range of the analog sensing means is larger than a potential dynamic range of the distribution of the application of energy in the heating chamber.

4. The electronic oven of claim 3, further comprising:
an analog to digital conversion means for generating a set of digital data points from a set of samples captured by the set of RF responsive sensors;
wherein the set of digital data points are in the set of training data.

5. The electronic oven of claim 3, wherein:
an input range of the analog sensing means is set by a physical dimension of the analog sensing means.

6. The electronic oven of claim 3, wherein:
a first RF responsive sensor in the set of RF responsive sensors is physically positioned at a first physical orientation to detect incoming energy at a first polarization;
a second RF responsive sensor in the set of RF responsive sensors is physically positioned at a second physical orientation to detect incoming energy at a second polarization;
a physical composition of the first RF responsive sensor and the second RF responsive sensor are the same; and
the first physical orientation and the second physical orientation are perpendicular.

7. The electronic oven of claim 1, wherein:
the control system alters a physical configuration of the electronic oven between a set of at least five fixed configurations by altering a physical position of a set of variable reflectance elements located in the heating chamber;
altering the physical configuration of the electronic oven adjusts the distribution of the application of energy in the heating chamber; and
each element in the set of training data represents: (i) a set of samples captured by the set of RF responsive sensors; and (ii) a corresponding configuration in the set of at least five fixed configurations.

8. (canceled)

9. (canceled)

10. The electronic oven of claim 1, further comprising:
a set of light emitting diodes;
a set of antennas, wherein each antenna in the set of antennas is electrically coupled to at least one light emitting diode in the set of light emitting diodes; and
a visible light camera with a view of the set of light emitting diodes.

11. The electronic oven of claim 10, wherein each light emitting diode in the set of light emitting diodes comprises:
a cathode connected to a first antenna in the set of antennas; and
an anode connected to a second antenna in the set of antennas.

12. The electronic oven of claim 10, wherein:
each antenna in the set of antennas has a uniform length; and
each antenna is electrically coupled to a number of diodes.

13. The electronic oven of claim 10, wherein:
the set of RF responsive sensors includes a first subset and a second subset;
each sensor in the first subset is physically positioned to detect incoming energy at a first polarization;
each sensor in the second subset is physically positioned to detect incoming energy at a second polarization;
the first polarization and the second polarization are different;
the first subset generates light of a first color;
the second subset generates light of a second color; and
the first color and the second color are different.

14. The electronic oven of claim 10, further comprising:
a ceramic floor panel;
wherein the set of antennas are located below the ceramic floor panel.

15. The electronic oven of claim 1, wherein each RF responsive sensor in the set RF responsive sensors:
absorbs 10 milliwatts to 100 milliwatts of power from the application of energy to the heating chamber; and
includes a dipole antenna of 0.5 centimeters to 2 centimeters in length.

16. A method for training a machine learning system for an electronic oven comprising:
applying an application of energy to a heating chamber of the electronic oven from an energy source via an injection port in the heating chamber;
adjusting a distribution of the application of energy in the heating chamber using a control system;
sensing the distribution of the application of energy in the heating chamber using a set of radio frequency (RF) responsive sensors, wherein the set of RF responsive sensors are: (i) located in the heating chamber;
creating a set of training data for the machine learning system using data from each RF responsive sensor in the set of RF responsive sensors; and
training the machine learning system using the set of training data.

17. The method of claim 16, further comprising:
altering a physical configuration of the electronic oven between a set of at least five fixed configurations to adjust the distribution of the application of energy in the heating chamber;
wherein each element in the set of training data represents: (i) a set of samples captured by the set of RF responsive sensors; and (ii) a corresponding configuration in the set of at least five fixed configurations.

18. The method of claim 16, wherein sensing the distribution of the application of energy in the heating chamber using a set of RF responsive sensors comprises:
forward biasing a set of light emitting diodes using the application of energy; and
detecting an intensity of light and a distribution of light from the set of light emitting diodes using a visible light camera.

19. The method of claim 18, wherein
each RF responsive sensor in the set of RF responsive sensors absorbs 10 milliwatts to 100 milliwatts of power from the application of energy to the heating chamber;
each RF responsive sensor in the set RF responsive sensors includes a dipole antenna of 0.5 centimeters to 2 centimeters in length; and
the set of RF responsive sensors is located behind an RF transparent wall of the heating chamber.

20. A non-transitory computer-readable medium storing instructions to enable an electronic oven to execute a method for training a machine learning system for the electronic oven, the method comprising:
applying an application of energy to a heating chamber of the electronic oven from an energy source via an injection port in the heating chamber;
adjusting a distribution of the application of energy in the heating chamber using a control system;
sensing the distribution of the application of energy in the heating chamber using a set of radio frequency (RF) responsive sensors, wherein the set of RF responsive sensors are: (i) located in the heating chamber; and (ii) include at least two elements;
creating a set of training data for the machine learning system using data from each RF responsive sensor in the set of RF responsive sensors; and
training the machine learning system using the set of training data.

21. The non-transitory computer-readable medium of claim 20, the method further comprising:
altering a physical configuration of the electronic oven between a set of at least five fixed configurations to adjust the distribution of the application of energy in the heating chamber;
wherein each element in the set of training data represents: (i) a set of samples captured by the set of RF responsive sensors; and (ii) a corresponding configuration in the set of at least five fixed configurations.

22. The non-transitory computer-readable medium of claim 20, wherein sensing the distribution of the application of energy in the heating chamber using a set of RF responsive sensors comprises:
forward biasing a set of light emitting diodes using the application of energy; and
detecting an intensity of light and a distribution of light from the set of light emitting diodes using a visible light camera.

23. The non-transitory computer-readable medium of claim 22, wherein each RF responsive sensor in the set of RF responsive sensors absorbs 10 milliwatts to 100 milliwatts of power from the application of energy to the heating chamber;
each RF responsive sensor in the set RF responsive sensors includes a dipole antenna of 0.5 centimeters to 2 centimeters in length; and
the set of RF responsive sensors are located behind an RF transparent wall of the heating chamber.

24. An electronic oven comprising:
a heating chamber;
an energy source coupled to an injection port in the heating chamber for introducing an application of energy into the heating chamber;
a control system to adjust a distribution of the application of energy in the heating chamber; and
a set of light emitting diodes;
a set of antennas, wherein each antenna in the set of antennas is electrically coupled to at least one light emitting diode in the set of light emitting diodes; and
a visible light camera with a view of the set of light emitting diodes
wherein the control system includes a machine learning system;
wherein the control system measures the distribution of the application of energy in the chamber using the visible light camera and the set of light emitting diodes;
wherein the control system uses data from the set of light emitting diodes as captured by the visible light camera to create a set of training data; and
wherein the machine learning system is trained using the set of training data.
